(19) United States
(12) Patent Application Publication
(10) Pub. No.: US 2014/0166691 A1
(43) Pub. Date: Jun. 19, 2014

(54) DISPENSING MECHANISM IN VENDING MACHINE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); LIANG TU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/947,566

(22) Filed: Jul. 22, 2013

(30) Foreign Application Priority Data
Dec. 17, 2012 (CN) 201210547384X

(51) Int. Cl. G07F 11/38

(52) U.S. Cl. CPC G07F 11/38
USPC 221/279

(57) ABSTRACT

A dispensing mechanism in a vending machine includes a rack, a first sliding rail, a second sliding rail, and a goods carrier. The first sliding rail is slidably mounted to the rack and the second sliding rail is slidably mounted to the first sliding rail. The goods carrier is secured to the second sliding rail. The goods carrier defines a space for accommodating goods and horizontal movements thereof allow the delivery of purchased goods individually.

### REFERENCE TO RELATED APPLICATIONS

This application claims all benefits accruing under 35 U.S.C. §119 from China Patent Application No. 201210547384.X filed on Dec. 17, 2012 in the State Intellectual Property Office of China, the contents of the China Application are hereby incorporated by reference.

### BACKGROUND

1. Technical Field

The present disclosure generally relates to vending machines, and particularly relates to dispensing mechanisms in vending machines.

2. Description of Related Art

Vending machines have been in common use for purchasing a variety of items such as snacks, beverages, alcohol, cigarettes, lottery tickets, cologne, consumer products and even gold and gems. A vending machine typically includes a dispensing mechanism for dispensing items to customers after the customers insert currency or credit into the vending machines. However, the conventional dispensing mechanism may be inflexible and not equipped to increasing demands.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a dispensing mechanism used in a vending machine.

FIG. 2 is similar to FIG. 1, but viewed from another aspect.

FIG. 3 is a partially assembled view of the dispensing mechanism of FIG. 1.

FIG. 4 is an assembled view of the dispensing mechanism apparatus of FIG. 1.

FIG. 5 is a cross-sectional view of the dispensing mechanism along a line V-V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

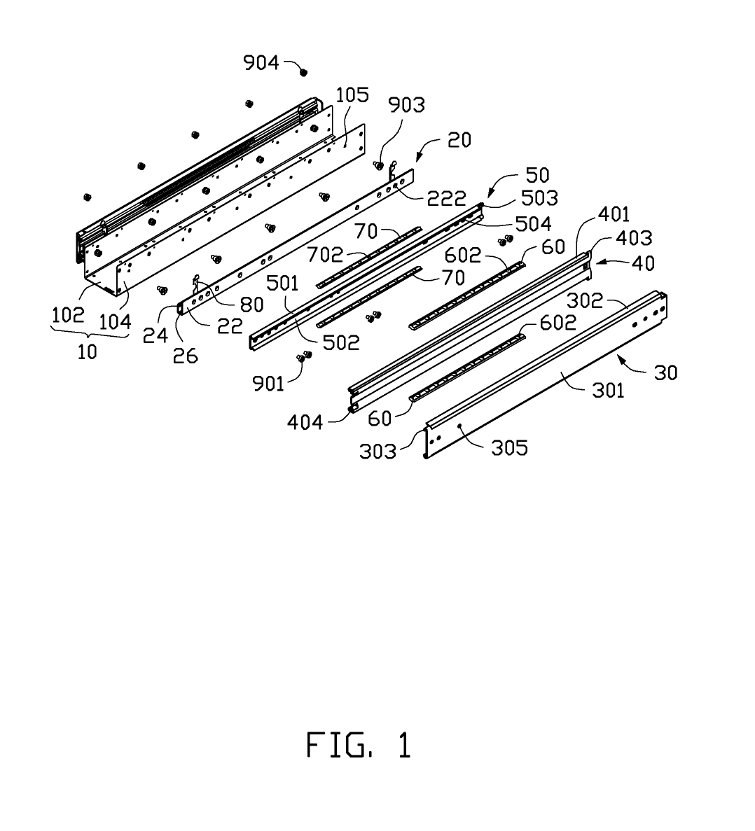

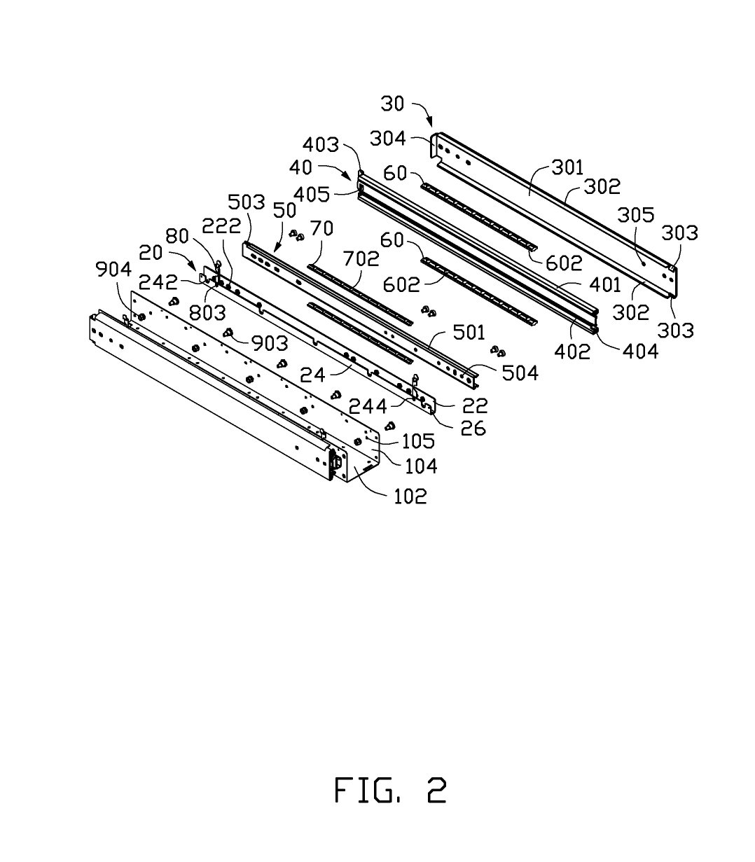

FIGS. 1 and 2 show an embodiment of a dispensing mechanism used in a vending machine. The dispensing machine includes a goods carrier 10, a U-shaped connecting member 20, a rack 30, a first sliding rail 40, a second sliding rail 50, a first sliding bar 60, a second sliding bar 70, a latching member 80, a plurality of screws 901 and 903, and a plurality of nuts 904.

The goods carrier 10 includes a bottom plate 102 and two sidewalls 104. The two sidewalls are perpendicular to the bottom plate 102. The two sidewalls are parallel to each other. Each of the two sidewalls 104 defines a plurality of mounting holes 105. The bottom plate 102 and the two sidewalls 104 define a space for accommodating goods.

The U-shaped connecting member 20 includes a first connecting plate 22, a second connecting plate 24, and a connecting plate 26. The first connecting plate 22 and the second connecting plate 24 extend upwards from two opposite sides of the connecting plate 26. The first connecting plate 22 and the second connecting plate 24 are parallel to each other. The first connecting plate 22 defines a plurality of threaded holes 222. The second connecting plate 24 defines a plurality of notches 242 and a plurality of mounting holes 244. Each of the notches 242 faces up.

The rack 30 includes an elongated plate 301, a pair of restricting plates 302, a pair of blocking flanges 303, and a blocking plate 304. The restricting plates 302 extend from two opposite sides of the elongated plate 301 and are perpendicular to the elongated plate 301. The blocking plate 304 is located at a first end of the elongated plate 301 and the blocking flanges 303 are located at a second end of the elongated plate 301. The blocking plate 304 is substantially perpendicular to the elongated plate 301. The elongated plate 301 defines a plurality of securing holes 305. The rack 30 may be secured to other structure (not shown) though the securing holes 305.

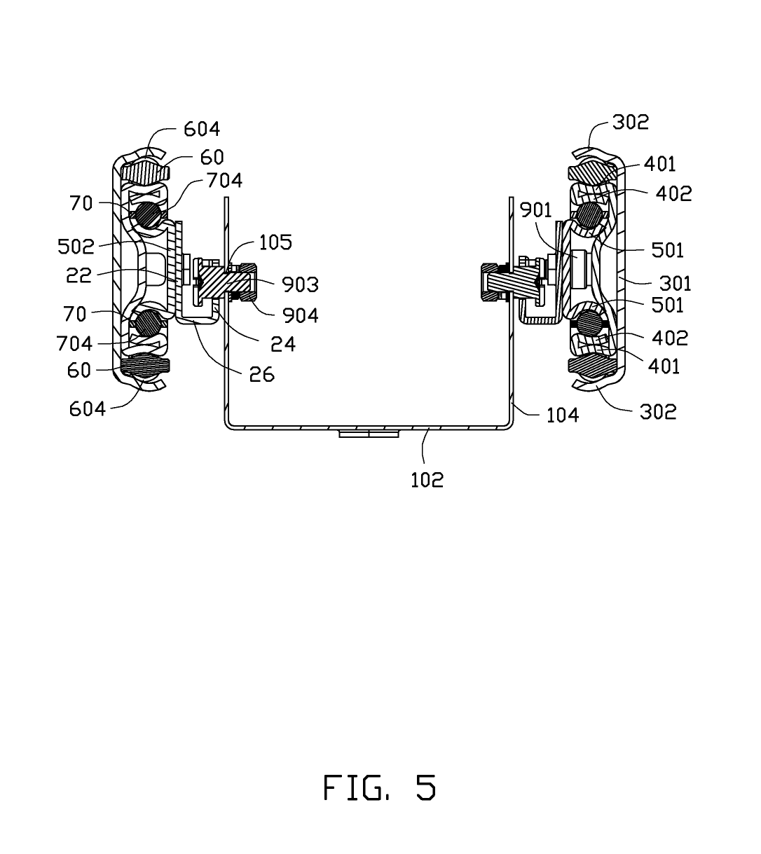

The first guiding rail 40 is elongated. A cross section of the first guiding rail 40 is substantially Σ-shaped. Referring to FIG. 5, the first guiding rail 40 includes a pair of first outer sliding portions 401 and a pair of first inner sliding portions 402.

A pair of first resisting protrusions 403 is located at a first end of the first guiding rail 40 and a pair of blocking protrusions 404 is located at a second end of the first guiding rail 40. A stopping plate 405 is located at the first end of the first guiding rail 40.

The second guiding rail 50 is substantially U-shaped. The second guiding rail 50 includes two second outer guiding portions 501 and a mounting wall 502. The two second outer guiding portions 501 extend from two opposite sides of the mounting wall 502. The mounting wall 502 defines a plurality of mounting holes 504. A pair of second resisting protrusions 503 is located at an end of the second guiding rail 50.

The first sliding bar 60 defines a plurality of though holes 602. A ball 604 is received in each of the plurality of through holes 602. A cross section of the first sliding bar 60 is substantially oval.

The second sliding bar 70 is similar to the first sliding bar 60. The second sliding bar 70 defines a plurality of though holes 702. A ball 704 is received in each of the plurality of through holes 702. A cross section of the second sliding bar 70 is substantially oval.

The latching member 80 is rotatably mounted to the second connecting plate 24 of the U-shaped connecting member 20. The latching member 80 includes a main plate 801 and a handling portion 802. The handling portion 802 extends from a free end of the latching member 80. The latching member 80 is rotatable about an axis 803. The main plate 801 defines a cutout 804.

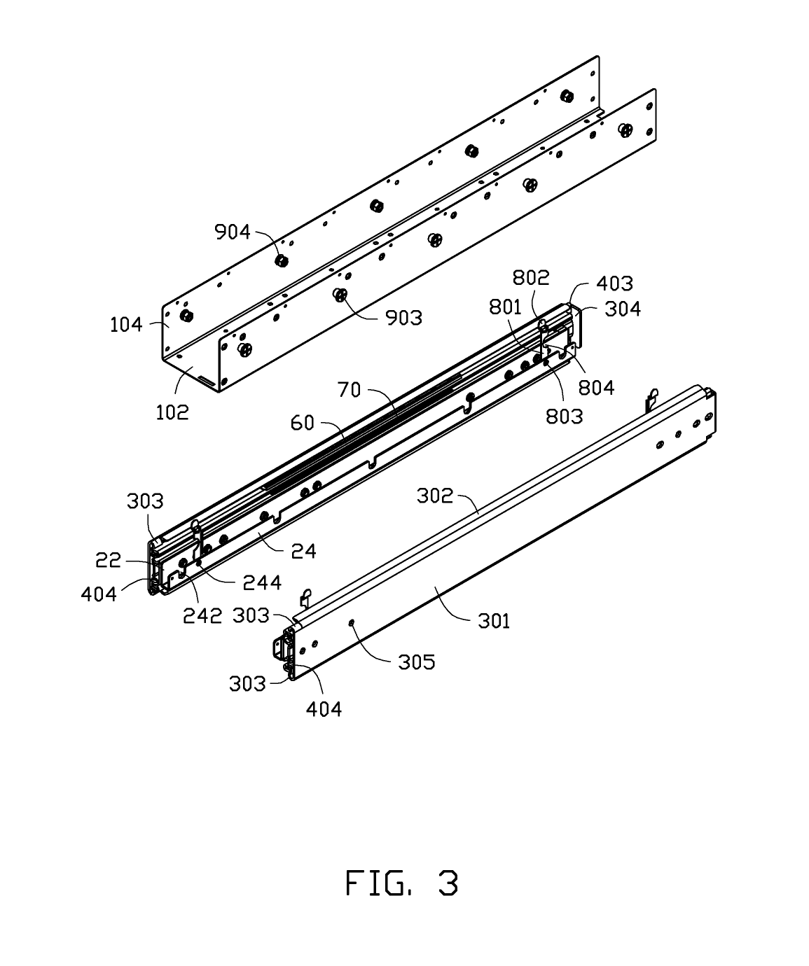

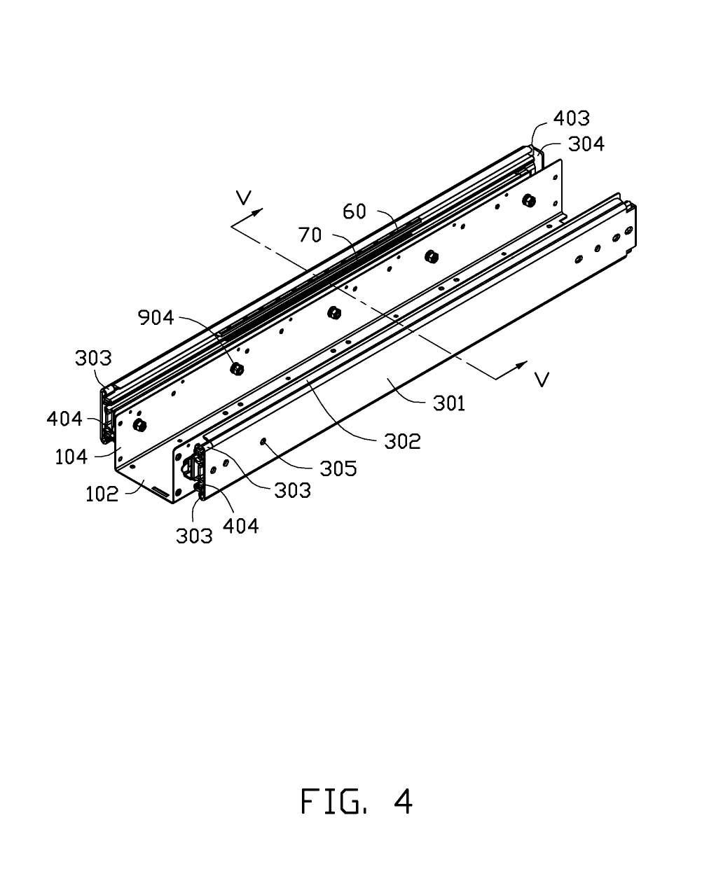

Referring to FIGS. 3-5, in assembly, the first guiding rail 40 is slidably mounted to the rack 30. The first outer sliding portions 401 of the first guiding rail 40 are engaged with the restricting plates 302 of the rack 30. Each first outer sliding portion 401 and the corresponding restricting plate 302 define a first receiving space in which the first sliding bar 60 is received. The first sliding bar 60 is sandwiched between the first outer sliding portion 401 and the corresponding restricting plate 302. Thus, the first guiding rail 40 is slidable relative to the rack 30.

The second sliding rail 50 is slidably mounted to the first guiding rail 40. The second outer guiding portions 501 of the second guiding rail 50 are engaged with the first inner sliding portions 402 of the first guiding rail 40. Each second outer sliding portion 501 and the corresponding first inner sliding portion 402 define a second receiving space in which the second sliding bar 70 is received. The second sliding bar 70 is sandwiched between the second outer sliding portion 501 and the corresponding first inner sliding portion 402. Thus, the second guiding rail 50 is slidable relative to the first guiding rail 40.

The first connecting plate 22 of the U-shaped connecting member 20 abuts against the mounting wall 502 of the second guiding rail 50. The threaded holes 222 of the first connecting plate 22 are aligned with the mounting holes 504 of the mounting wall 502. The screws 901 are inserted into the mounting holes 504 and the threaded holes 222. Thus, the first connecting plate 22 of the U-shaped connecting member 20 is secured to the second guiding rail 50.

The screws 903 are inserted into the mounting holes 105 of the two sidewalls 104 of the goods carrier 10. Each screw 903 is engaged with one of the nuts 904. Thus, the screws 903 are secured to the sidewalls 104 of the goods carrier 10.

The latching member 80 is firstly rotated to an unlocked position. Outer portions of the screws 903 are aligned with and received in the notches 242 of the second connecting plate 24 of the U-shaped connecting member 20. The latching member 80 is then rotated to a locked position wherein the cutout 804 is engaged with the outer portion of one of the screws 903. Thus, the second connecting plate 24 of the U-shaped connecting member 20 is secured to the goods carrier 10. Thereby, the goods carrier 10 is secured to the second sliding rail 50.

When the first guiding rail 40 moves a first certain distance in a first direction relative to the rack 30, one end of the first sliding bar 60 abuts the first resisting protrusions 403 and another end of the first sliding bar 60 abuts the blocking flanges 303 thereby preventing the first guiding rail 40 from moving away from the rack 30 in the first direction. The blocking plate 304 prevents the first guiding rail 40 from moving away from the rack 30 in a second direction which is opposite to the first direction.

When the second guiding rail 50 moves a second certain distance in the first direction relative to the first guiding rail 40, one end of the second sliding bar 70 abuts the second resisting protrusion 503 and another end of the second sliding bar 70 abuts the blocking protrusion 404 thereby preventing the second guiding rail 50 from moving away from the first guiding rail 40 in the first direction. The stopping plate 405 prevents the second guiding rail 50 from moving away from the first guiding rail 40 in the second direction.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A dispensing mechanism, comprising:
a rack;
a first sliding rail slidably mounted to the rack;
a second sliding rail slidably mounted to the first sliding rail; and
a goods carrier secured to the second sliding rail, wherein the goods carrier defines a space for accommodating goods.

2. The dispensing mechanism of claim 1, further comprising a U-shaped connecting member, wherein the U-shaped connecting member comprises two connecting plates, one of the two connecting plates is secured to the second sliding rail and another one of the two connecting plates is secured to the goods carrier.

3. The dispensing mechanism of claim 1, further comprising a first sliding bar sandwiched between the first sliding rail and the rack.

4. The dispensing mechanism of claim 3, further comprising a plurality of first balls, wherein the first sliding bar defines a plurality of first through holes, each of the plurality of first balls is received in one of the plurality of first through holes.

5. The dispensing mechanism of claim 3, wherein the rack comprises an elongated plate and a blocking flange located at an end of the elongated plate, the blocking flange is configured to prevent the first sidling bar from moving away from the rack in a first direction.

6. The dispensing mechanism of claim 5, wherein a first resisting protrusion is located at a first end of the first guiding rail, when the first guiding rail moves a first distance in the first direction relative to the rack, one end of the first sliding bar abuts the first resisting protrusion and another end of the first sliding bar abuts the blocking flange thereby preventing the first guiding rail from moving away from the rack in the first direction.

7. The dispensing mechanism of claim 5, further comprising a second sliding bar sandwiched between the first sliding rail and the second sliding rail.

8. The dispensing mechanism of claim 7, further comprising a plurality of second balls, wherein the second sliding bar defines a plurality of second through holes, each of the plurality of second balls is received in one of the plurality of second through holes.

9. The dispensing mechanism of claim 7, wherein a blocking protrusion is located at a second end of the first guiding rail, the blocking protrusion is configured to prevent the second sidling bar from moving away from the first guiding rail in the first direction.

10. The dispensing mechanism of claim 9, wherein a second resisting protrusion is located at a first end of the second guiding rail, when the second guiding rail moves a second distance in the first direction relative to the first guiding rail, one end of the second sliding bar abuts the second resisting protrusion and another end of the second sliding bar abuts the blocking protrusion thereby preventing the second guiding rail from moving away from the first guiding rail in the first direction.

11. A dispensing mechanism, comprising:
a rack comprising two restricting plates;
a first sliding rail slidably mounted to the rack and located between the two restricting plates;
a second sliding rail slidably mounted to the first sliding rail; and
a goods carrier secured to the second sliding rail, wherein the goods carrier defines a space for accommodating goods.

12. The dispensing mechanism of claim 11, further comprising a U-shaped connecting member, wherein the U-shaped connecting member comprises two connecting plates, one of the two connecting plates is secured to the second sliding rail and another one of the two connecting plates is secured to the goods carrier.

13. The dispensing mechanism of claim 11, further comprising a first sliding bar sandwiched between the first sliding rail and the rack.

14. The dispensing mechanism of claim 13, further comprising a plurality of first balls, wherein the first sliding bar defines a plurality of first though holes, each of the plurality of first balls is received in one of the plurality of first through holes.

15. The dispensing mechanism of claim 13, wherein the rack comprises an elongated plate and a blocking flange located at an end of the elongated plate, the blocking flange is configured to prevent the first sidling bar from moving away from the rack in a first direction.

16. The dispensing mechanism of claim 15, wherein a first resisting protrusion is located at a first end of the first guiding rail, when the first guiding rail moves a first distance in the first direction relative to the rack, one end of the first sliding bar abuts the first resisting protrusion and another end of the first sliding bar abuts the blocking flange thereby preventing the first guiding rail from moving away from the rack in the first direction.

17. The dispensing mechanism of claim 15, further comprising a second sliding bar sandwiched between the first sliding rail and the second sliding rail.

18. The dispensing mechanism of claim 17, further comprising a plurality of second balls, wherein the second sliding bar defines a plurality of second though holes, each of the plurality of second balls is received in one of the plurality of second through holes.

19. The dispensing mechanism of claim 17, wherein a blocking protrusion is located at a second end of the first guiding rail, the blocking protrusion is configured to prevent the second sidling bar from moving away from the first guiding rail in the first direction.

20. The dispensing mechanism of claim 19, wherein a second resisting protrusion is located at a first end of the second guiding rail, when the second guiding rail moves a second distance in the first direction relative to the first guiding rail, one end of the second sliding bar abuts the second resisting protrusion and another end of the second sliding bar abuts the blocking protrusion thereby preventing the second guiding rail from moving away from the first guiding rail in the first direction.
